(19) United States
(12) Patent Application Publication
(10) Pub. No.: US 2024/0194874 A1
(43) Pub. Date: Jun. 13, 2024

(54) NEGATIVE ELECTRODE FOR LITHIUM/SODIUM ION BATTERY WITHOUT SURFACE LITHIUM/SODIUM DEPOSITION PHENOMENA AND PREPARATION METHOD THEREOF

(71) Applicant: Yangtze Delta Region Institute (Huzhou), University of Electronic Science and Technology of China, Huzhou City (CN)

(72) Inventors: Jingze LI, Huzhou City (CN); Zhicui SONG, Huzhou City (CN); Zihao WANG, Huzhou City (CN); Xiaohui LV, Huzhou City (CN); Jianxiong XING, Huzhou City (CN)

(21) Appl. No.: 18/387,238

(22) Filed: Nov. 6, 2023

(30) Foreign Application Priority Data
Nov. 28, 2022 (CN) 2022115033483

(51) Int. Cl. H01M 4/583; H01M 4/02; H01M 4/04; H01M 4/62; H01M 10/0525

(52) U.S. Cl. CPC H01M 4/583; H01M 4/0404; H01M 4/0423; H01M 4/0428; H01M 4/623; H01M 4/625; H01M 4/628; H01M 2004/021; H01M 2004/027; H01M 10/0525

(57) ABSTRACT

Disclosed is a negative electrode for a lithium/sodium ion battery and a preparation method therefor, belonging to the field of metal ion battery. The negative electrode includes an electron insulating modification layer and a conventional negative electrode for a lithium/sodium ion battery; the electron insulating modification layer is confinedly coated on the surface of the conventional negative electrode for the lithium/sodium ion battery, forming a porous thin film; and the conventional negative electrode for the lithium/sodium ion battery includes a metal current collector and a powder composite layer of negative electrode, including an active material, a conductive additive, and a binder.

### PRIORITY APPLICATION

This application claims priority under 35 U.S.C. § 119(a) to Chinese Patent Application No. 2022115033483, filed on Nov. 28, 2022, which is hereby incorporated by reference herein in its entirety.

### TECHNICAL FIELD

The present disclosure belongs to the field of metal ion battery, more particularly, relates to a negative electrode sheet for preventing lithium/sodium deposition phenomena on the surface of a negative electrode for a lithium/sodium ion battery, and a preparation method and a use thereof.

### BACKGROUND

During the operation of lithium-ion batteries, due to reasons such as mismatched capacities between the negative electrode and positive electrode, rapid charging and discharging, other design flaws or misuse, some lithium ions cannot be normally stored and accommodated by the active material of the negative electrode. Due to the shorter lithium ion diffusion path on the electrode surface, as well as the excellent electrical conductivity of active material particles and conductive additives, lithium ions on the surface of the negative electrode are easily reduced to lithium atoms by electrons. If these lithium atoms cannot be quickly stored and absorbed by the active material, they will aggregate on the negative electrode surface forming metallic lithium, a phenomenon also known as lithium plating. This metallic lithium usually exists in dendritic form, not only consuming electrolyte but also easily generating inactive “dead” lithium and uneven Solid Electrolyte Interface (SEI) layers, thereby deteriorating the cycling performance, which is one of the significant causes leading to the performance degradation of lithium-ion batteries. Furthermore, dendritic lithium formations are prone to piercing through the separator, causing internal short circuits within the battery, and may even lead to catastrophic consequences such as fires and explosions.

Therefore, suppressing lithium plating and dendritic growth on the surface of the negative electrode is extremely important for enhancing the safety performance and electrochemical performance of the battery. Although the current methods, such as forming a lithium-ion buffering layer by coating active material with a conductive carbon layer or using metal oxide modifications to improve an electrolyte wettability and thereby accelerate the storage rate of lithium ions, have improved the fast charging performance of batteries, the problem of lithium plating still exists. Coating an insulating layer on the surface of the active material is a viable method, constructing a surface-insulated core-shell structure, effectively preventing lithium ions on the surface of the active material from being reduced by electrons to metallic lithium. However, the drawbacks of this method are also very apparent. The core-shell coating reduces the effective contact area between active material particles, significantly decreases the electron transport path within the negative electrode, and relies more on the electron tunneling effect between active materials to ensure the smooth progress of electrochemical reactions. Therefore, it is usually required that the coating layer be thin to enhance the electron tunneling effect. In reality, the transmission rate of the electron tunneling effect is far slower than the direct electron transmission between particles, which will inevitably lead to a rapid decline in the rate performance of the battery. From the material preparation perspective, a thin coating layer increases the difficulty of the production process, requires higher equipment standards, and significantly raises costs, making it difficult to implement on a large scale at present. On the other hand, if the coating layer is sticky, it will cause adhesion between active material particles, poor dispersion, which is not conducive to the uniform mixing of active particles, conductive additives, and binders, leading to poor preparation results of the subsequent electrode sheets. Since the working principle of sodium-ion batteries is similar to that of lithium-ion batteries, the aforementioned phenomena and dilemmas also occur in the field of sodium-ion batteries. Therefore, there is an urgent need to provide a new structure and preparation method for negative electrodes for lithium/sodium ion battery, which can effectively prevent metallic lithium/sodium deposition on the electrode surface, and improve the safety and electrochemical performance of lithium/sodium ion batteries.

### SUMMARY

The present disclosure provides a method and a use for preparing a negative electrode coated with a confined insulating layer for a lithium/sodium ion battery. By spraying a layer of electronically insulating layer with controllable thickness on the surface of the negative electrode, restricting the diffusion rate of the sprayed liquid, and accelerating the evaporation of the solvent, only powder particles of the upper layer in the negative electrode are conformally coated, without coating the particles in the middle and bottom layers of the composite electrode. This confined coating essentially does not affect the internal porosity of the negative composite electrode, preserving the lithium ion diffusion channels and the electron transport channels between internal particles. The insulating layer not only prevents the deposition of metallic lithium/sodium on the electrode surface and subsequent lithium/sodium dendrite formation, but also reduces the real active surface area of the electrode, effectively enhancing the safety and stability of the negative electrode, and increasing the Coulombic efficiency of the lithium/sodium ion battery.

The present disclosure is achieved through the following technical solutions:

According to a first aspect, the present disclosure provides a negative electrode for a lithium/sodium ion battery without surface lithium/sodium deposition phenomena and its preparation method, characterized by, comprising a commercial negative electrode for a lithium/sodium ion battery and an electron insulating modification layer confinedly coated on its upper layer; the commercial negative electrode for the lithium/sodium ion battery includes a metal current collector, a powder composite layer (active material, conductive additive, binder, etc.) of negative electrode, an active material, a conductive additive, a binder, etc.; the electronic insulating layer has a thickness of 10-1000 nm; conformally coated on the surface of particles in upper layer of the composite negative electrode, forming a porous thin film.

Further, according to one or more embodiments of the present disclosure, the aforementioned coating component is an electronically insulating or low electronic conductivity organic material, polymer, inorganic material, or a mixture of two or more thereof.

Further, according to one or more embodiments of the present disclosure, the aforementioned organic or polymer insulating components can be dissolved in a solvent, with or without the addition of inorganic insulating components, to form a solution. Preferably, the insulating components include at least one of EVOH, EPDM, PVDF-HFP, PAA, PVDF, Li₂S, Li₂O.

Further, according to one or more embodiments of the present disclosure, the aforementioned solvent refers to an aqueous solution or organic solvent, including at least one of DMF, DMAC, DMSO, n-hexane, NMP, etc.

Further, according to one or more embodiments of the present disclosure, the aforementioned inorganic insulating layer can be prepared by methods of physical vapor deposition or chemical vapor deposition, wherein the inorganic insulating materials include Al₂O₃, Li₃PO₄, etc.

According to a second aspect, the present disclosure provides a preparation method of a negative electrode for a lithium/sodium ion battery with the confined conformal coating of an electronic insulating modification layer as mentioned above, which includes:

Dissolving at least one of the organic or polymer insulating components, with or without the addition of inorganic insulating components, in a solvent while employing magnetic stirring at a temperature of 25-80° C. to form a solution.

Preparing a lithium ion negative electrode sheet by coating the active material of the commercial negative electrode for the lithium/sodium ion battery on a metal foil current collector using traditional slurry coating methods.

Spraying the solution onto the surface of the conventional negative electrode sheet for the lithium/sodium ion battery through a spray method, followed by immediate high-temperature drying (40-120° C.), enabling a rapid evaporation of the solvent, to obtain a confined conformally coated modified negative electrode sheet with an insulating layer only on the particles in the top surface of the negative electrode sheet, while the interior of the negative electrode sheet has no insulating coating layer.

Wherein, the temperature for dissolving the insulating coating material is 25-80° C., preferably, this temperature is 40-70° C., more preferably ˜60° C.

The high-temperature drying temperature is 40-120° C., preferably, the drying temperature is 50-100° C., more preferably 60-90° C.

According to one or more embodiments, in the presence or absence of inorganic insulating components, the organic and polymer components of the insulating coating material forming the solution include at least one of EVOH, EPDM, PVDF-HFP, PAA, PVDF, and the inorganic insulating components include at least one of Li₂S, Li₂O, etc.

According to one or more embodiments, the solvent refers to an aqueous solution or organic solvent, including at least one of DMF, DMAC, DMSO, n-hexane, NMP, etc.

Specifically, the inorganic insulating layer can be prepared by methods of physical vapor deposition or chemical vapor deposition, wherein the inorganic insulating materials include Al₂O₃, Li₃PO₄, etc.

According to one or more embodiments, the physical vapor deposition method includes magnetron sputtering, electron beam coating, thermal evaporation coating, etc., and the chemical vapor deposition method includes plasma-enhanced chemical vapor deposition, atomic layer deposition, etc.

According to a third aspect, the present disclosure provides a negative electrode sheet for a lithium/sodium ion battery with no surface lithium/sodium deposition phenomenon, which includes a negative electrode current collector, as well as a powder composite layer of negative electrode and a confined conformal insulating modification layer on the top layer.

According to one or more embodiments, the powder composite layer of negative electrode includes an active material of commercially applied negative electrode for a lithium/sodium ion battery, a conductive additive, and a binder.

According to one or more embodiments, the active material of the commercially applied negative electrode for the lithium/sodium ion battery includes at least one of graphite, silicon-carbon composite material, hard carbon, or silicon oxide.

According to one or more embodiments, the conductive additive includes at least one of conductive carbon black or carbon nanotubes.

According to one or more embodiments, the binder includes at least one of sodium carboxymethyl cellulose, polyvinylidene fluoride, polyacrylic acid, styrene-butadiene rubber, polyepichlorohydrin, polyvinyl alcohol, or polyacrylonitrile.

According to a fourth aspect, the present disclosure provides a commercially applicable lithium/sodium ion battery, which includes a positive electrode sheet, a liquid electrolyte, and the aforementioned negative electrode sheet for the lithium/sodium ion battery coated by the confined insulating layer.

Compared to the prior art, the present disclosure has at least the following technical effects:

1. The negative electrode for the lithium/sodium ion battery provided by the present disclosure, which exhibits no surface lithium/sodium deposition phenomenon, employs a spray method to apply a solution containing insulating components onto the surface of the negative electrode for the lithium/sodium ion, or utilizes physical vapor deposition or chemical vapor deposition methods to only coat a thin and uniform insulating layer (10-1000 nm) on the upper part of the powder composite layer of negative electrode, while the middle and lower parts of the powder composite layer of negative electrode are not subjected to insulating coating treatment. Compared to the existing technology of powder particles coated with active materials, the method of directly spraying or depositing an insulating coating layer on the negative electrode sheet is simple, strongly compatible with existing production preparation processes, and the coating effect is uniform, stable, and efficient, capable of covering large-area electrode sheets. This avoids issues related to poor dispersion and later-stage uniform mixing of conductive additives and binders due to the high viscosity of the coating material, as well as slurry coating problems. At the same time, the spraying method achieves controlled coating depth, reducing the area of particle coating, and thereby lowering material costs.

2. Through confined coating on the negative electrode sheet for the lithium/sodium ion, the present disclosure achieves a controlled electron insulating modification layer only coated on the upper layer of the powder composite layer of negative electrode. This confined insulation design not only prevents the deposition of metallic lithium/sodium on the electrode surface and subsequent lithium dendrite formation but also reduces the true active surface area of the electrode, effectively enhancing the safety and stability of the negative electrode. Furthermore, it barely affects the lithium ion diffusion channels within the internal pores of the electrode and the electron transmission channels between internal particles.

3. The present disclosure achieves a conformal confined coating effect on the surface of the negative electrode sheet for the lithium/sodium ion battery through a spraying method. By adjusting parameters such as solution viscosity, spray atomization degree, and number of spraying cycles, combined with rapid drying of the solvent at high temperatures, the dispersion depth is kept low. A method of gradually spraying to wet the surface of the negative electrode sheet is employed to realize confined insulating coating of the top powder particles. The thickness of this coating layer is controllable (10-1000 nm), the confined depth is adjustable, coating material loss is minimal, and the coating layer structure is a porous thin film.

4. The insulating coating layer formed in this disclosure utilizes coating materials that are electron insulating or have low electronic conductivity, which prevents lithium/sodium ions from accumulating on the electrode surface and increases internal polarization of the battery, thereby improving the actual capacity and cycle life of the battery.

5. The confined insulating coating layer designed by this disclosure only passivates the top particles of the powder composite layer of negative electrode and possesses higher mechanical strength. This design avoids issues of coating layer damage caused by the internal stress brought about by the repeated intercalation and de-intercalation of lithium/sodium ions during cycling processes, maintaining the stability of the negative electrode structure and effectively enhancing the safety performance of the battery.

### BRIEF DESCRIPTION OF THE SEVERAL VIEWS OF THE DRAWINGS

FIG. 1 is a schematic diagram of the structure of a confined conformally insulated coating negative electrode sheet for a lithium/sodium ion prepared in Embodiment 1;

FIG. 2 is a Scanning Electron Microscope (SEM) image of the surface of a negative electrode sheet after top insulating coating prepared in Embodiment 2;

FIG. 3 is a Scanning Electron Microscope (SEM) image of the negative electrode for a lithium ion battery after lithium overcharging prepared in Embodiment 2;

FIG. 4 is a cycle life diagram of the half-cell prepared in Embodiment 3; and

FIG. 5 is a Coulombic efficiency diagram of the half-cell prepared in Embodiment 3 under the condition of over-lithiation by 30%.

### DETAILED DESCRIPTION

The following detailed description will be provided in conjunction with embodiments to explain the implementation schemes of the present disclosure. However, those skilled in the art will understand that the following embodiments are only for illustrating the present disclosure and should not be seen as limiting the scope of the present disclosure. Specific conditions not mentioned in the embodiments are carried out according to conventional conditions or conditions recommended by manufacturers. Reagents or instruments not specified with manufacturers are all conventional products that can be available through market sales.

Below, a detailed explanation of the specific embodiments of the present disclosure is provided. It should be understood that the specific embodiments described here are only for the purpose of illustrating and explaining the present disclosure, and are not intended to limit the present disclosure.

### Embodiment 1

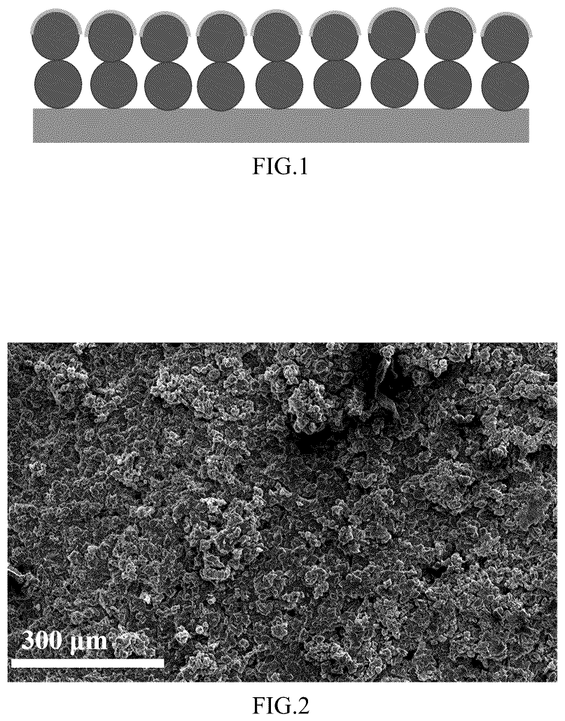

This embodiment provides a negative electrode for a lithium-ion battery without surface lithium deposition phenomena, as shown in FIG. 1. It includes a commercial negative electrode for the lithium-ion battery and an electron insulating modification layer confined conformally coated on the upper layer. The commercial negative electrode for the lithium-ion battery includes a metal current collector and a powder composite layer (an active material, a conductive additive, and a binder, etc.) of negative electrode.

The preparation method of the negative electrode for the lithium-ion battery without surface lithium deposition phenomena includes:
(1) The commercially available active material (hard carbon) of a negative electrode for a lithium-ion battery, a conductive additive acetylene black, and binder PVDF are mixed uniformly in the organic solvent NMP to obtain a negative electrode slurry. Then, the negative electrode slurry is evenly coated on the surface of the copper foil current collector, and after drying and rolling, a hard carbon negative electrode sheet is obtained.
(2) PVDF-HFP copolymer is added to the DME solvent and stirred on a magnetic stirrer until fully dissolved.
(3) The obtained PVDF-HFP copolymer solution is loaded into a high-pressure vacuum spray bottle, and the PVDF-HFP copolymer solution is sprayed onto the prepared hard carbon electrode sheet using a spray coating method.
(4) The obtained electrode sheet is quickly placed in a 100° C. vacuum drying oven for high-temperature drying. By controlling the number of PVDF-HFP copolymer spray coatings, a hard carbon electrode sheet coated with PVDF-HFP copolymer insulating layer with a thickness of 200 nm is obtained.

This embodiment also provides a lithium battery comprising a graphite negative electrode with a helmet-type coating of PVDF-HFP copolymer. The lithium battery includes a positive electrode sheet, an electrolyte, and the aforementioned negative electrode sheet. The preparation method of the lithium battery includes:

A positive active material (NCM811), a conductive additive (conductive carbon black), and a binder (PVDF) are mixed uniformly in solvent NMP to obtain a positive electrode slurry. Then, the positive electrode slurry is evenly coated on the positive current collector aluminum foil, and after drying and rolling, a positive electrode sheet is obtained. The aforementioned negative electrode sheet, an ester electrolyte, a separator, and the positive electrode sheet are assembled to obtain a lithium battery.

### Embodiment 2

This embodiment provides a negative electrode for a lithium-ion battery without surface lithium deposition phenomena, with a structure consistent with Embodiment 1. The preparation method includes:
(1) The commercially available active material (graphite) of a negative electrode for a lithium-ion battery, a conductive additive acetylene black, and binders CMC and SBR are mixed uniformly in a water solvent to obtain a negative electrode slurry. The slurry is then evenly coated onto the surface of the copper foil current collector, and after drying and rolling, a graphite negative electrode sheet is obtained.
(2) EVOH polymer is added to the DMSO solvent, and heated and stirred at a temperature of 60° C. on a heating platform until fully dissolved.
(3) The obtained EVOH solution is loaded into a high-pressure vacuum spray bottle, and the EVOH solution is sprayed onto the prepared graphite electrode sheet using a spray coating method.
(4) The obtained electrode sheet is quickly placed in a 100° C. vacuum drying oven for high-temperature drying. By controlling the EVOH concentration to 0.5%, a graphite electrode sheet coated with the EVOH insulating layer with a thickness of 1 μm is obtained.

The scanning electron microscope image of the EVOH insulating coated graphite negative electrode is shown in FIG. 2. As can be seen from FIG. 2, the EVOH coating layer prepared by the above method can conform well to the surface undulations of the graphite particles and closely adhere to the surface of the top graphite particles, indicating successful top insulating coating.

This embodiment also provides a half-cell with EVOH insulating coated graphite as the negative electrode and metallic lithium foil as the counter electrode. This half-cell is assembled by combining a counter electrode lithium foil, an ester electrolyte, a separator, and the aforementioned negative electrode sheet.

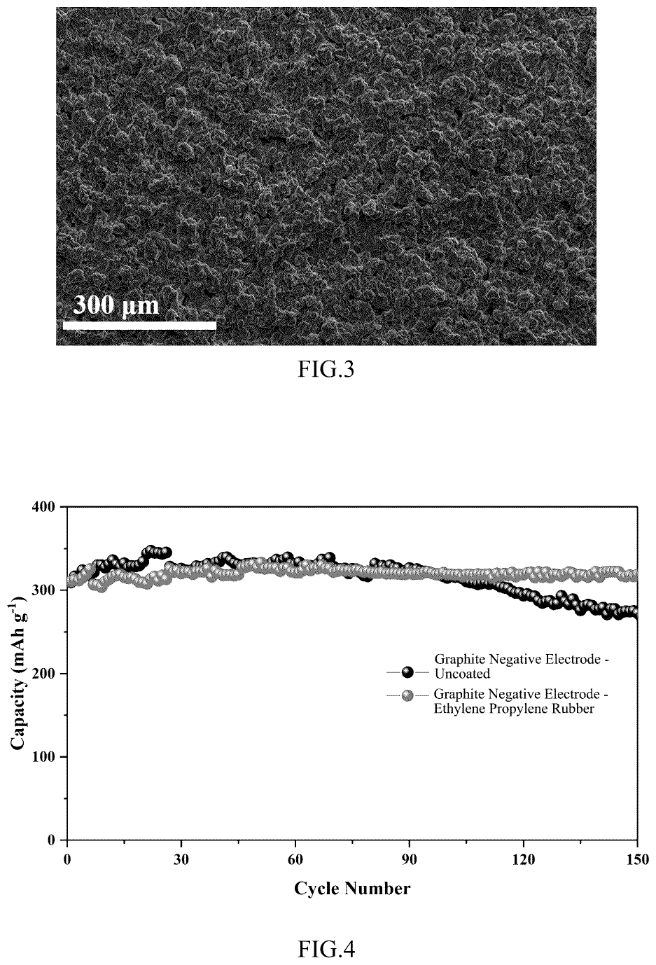

The half-cell is subjected to battery charging and discharging tests. As shown in the scanning electron microscope image in FIG. 3, even in extreme cases where the lithium deposition amount is excessive by 30%, no significant lithium accumulation is observed on the surface of the insulating coated graphite negative electrode, indicating that top insulating coating achieves the construction of lithium-ion negative electrodes without surface lithium deposition. Additionally, this phenomenon also proves that the working potential of the constructed modified negative electrode can be below 0 V vs. Li/Li⁺, effectively improving the specific capacity of the negative electrode, essentially constructing a hybrid battery of lithium-ion batteries and lithium batteries.

This embodiment also provides a lithium battery comprising an EVOH insulating layer coated graphite negative electrode, which includes a positive electrode sheet, an electrolyte, and the aforementioned negative electrode sheet. The preparation method of the lithium battery includes:

a positive active material (LiFePO₄), a conductive additive (conductive carbon black), and binder (PVDF) are mixed uniformly in the solvent NMP to obtain a positive electrode slurry. Then, the positive electrode slurry is evenly coated on the positive current collector aluminum foil, and after drying and rolling, a positive electrode sheet is obtained. The aforementioned negative electrode sheet, an ester electrolyte, a separator, and the positive electrode sheet are assembled to obtain the lithium battery.

### Embodiment 3

This embodiment provides a negative electrode for a lithium-ion battery with no surface lithium deposition phenomenon, its structure being consistent with Embodiment 1. The preparation method includes:
(1) The commercially available active material (graphite) of a negative electrode for a lithium-ion battery, a conductive additive acetylene black, and binders CMC and SBR are mixed uniformly in a water solvent to obtain a negative electrode slurry. The slurry is then evenly coated onto the surface of the copper foil current collector, and after drying and rolling, a graphite negative electrode sheet is obtained.
(2) Ethylene-propylene rubber polymer is added to a hexane solvent, and stirred under a magnetic stirrer until fully dissolved.
(3) The obtained ethylene-propylene rubber solution is loaded into a high-pressure vacuum spray bottle, and the ethylene-propylene rubber solution is sprayed onto the prepared graphite electrode sheet using a spray coating method.
(4) The obtained electrode sheet is quickly placed in an 80° C. vacuum drying oven for high-temperature drying. By controlling the ethylene-propylene rubber concentration to 0.5%, a graphite electrode sheet coated with the ethylene-propylene rubber insulating layer with a thickness of 500 nm is obtained.

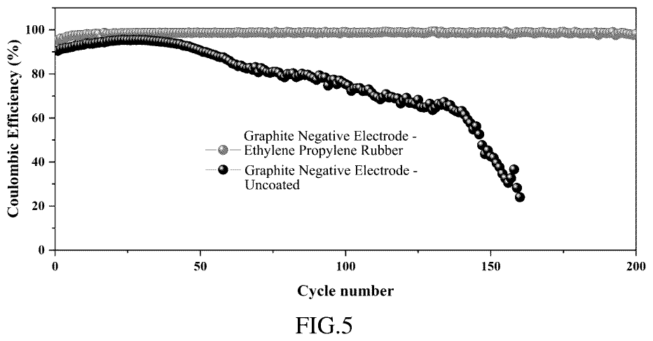

This embodiment also provides a half-cell with ethylene-propylene rubber insulating coated graphite as the negative electrode and metallic lithium foil as the counter electrode. This half-cell is assembled by combining the counter electrode lithium foil, an ester electrolyte, a separator, and the aforementioned negative electrode sheet. Through normal charge-discharge testing (0.01-3V, 1C), the results are as shown in FIG. 3. Since the coating method of ethylene-propylene rubber did not affect the internal electron/ion transmission channels within the pores, the coated electrode exhibits a capacity on par with pure graphite negative electrode without affecting the normal capacity performance. However, in the later cycles, the ethylene-propylene rubber coated graphite negative electrode shows superior capacity retention, which can primarily be attributed to the coating layer passivating the electrode surface, inhibiting the deposition of metallic lithium on the electrode surface, and reducing side reactions. During the discharge process, excess lithium of 30% is extracted from the lithium foil to the ethylene-propylene rubber coated graphite negative electrode, and then charged to 1.5 V for corresponding Coulombic efficiency testing. The results as shown in FIG. 5 demonstrate that after helmet-type coating modification with ethylene-propylene rubber, due to the reduction of active surface area of surface particles on the graphite negative electrode, and the inhibition of metallic lithium deposition on the electrode surface forming dendrites causing safety issues and rapid capacity decay, the modified negative electrode can achieve up to 98.54% average Coulombic efficiency even after 200 cycles in an ester electrolyte. Whereas, the uncoated graphite negative electrode, due to excessive lithium deposition at the top evolving into dead lithium, results in rapid capacity loss and significant drop in Coulombic efficiency.

This embodiment also provides a lithium battery comprising an ethylene-propylene rubber insulating coated graphite negative electrode, which includes a positive electrode sheet, electrolyte, and the aforementioned negative electrode sheet. The preparation method of the lithium battery includes:

a positive active material (LiFePO₄), a conductive additive (conductive carbon black), and a binder (PVDF) are mixed uniformly in the solvent NMP to obtain a positive electrode slurry. Then, the positive electrode slurry is evenly coated on the positive current collector aluminum foil, and after drying and rolling, a positive electrode sheet is obtained. The aforementioned negative electrode sheet, an ester electrolyte, a separator, and the positive electrode sheet are assembled to obtain the lithium battery.

### Embodiment 4

This embodiment provides a negative electrode for a lithium-ion battery with no surface lithium deposition phenomenon, its structure being consistent with Embodiment 1. The preparation method includes:
(1) The commercially available active material (silicon-carbon composite) of a negative electrode for a lithium-ion battery, a conductive additive acetylene black, carbon nanotubes, and binders CMC and SBR are mixed uniformly in a water solvent to obtain a negative electrode slurry. The slurry is then evenly coated onto the surface of the copper foil current collector, and after drying and rolling, a silicon-carbon negative electrode sheet is obtained.
(2) EVOH polymer and inorganic material Li₂O are added to the DMSO solvent, and heated and stirred at a temperature of 60° C. on a heating plate until fully dissolved.
(3) The obtained EVOH-Li₂O composite solution is loaded into a high-pressure vacuum spray bottle, and sprayed onto the prepared silicon-carbon electrode sheet using a spray coating method.
(4) The obtained electrode sheet is quickly placed in an 80° C. vacuum drying oven for high-temperature drying. The ratio between EVOH and Li2O is controlled so that the total concentration is 1%. A silicon-carbon negative electrode coated with an insulating inorganic-polymer mixed coating layer of 150 nm thickness is obtained.

This embodiment also provides a lithium battery comprising the aforementioned inorganic-polymer (EVOH-Li₂O) mixed coated silicon-carbon negative electrode, which includes a positive electrode sheet, electrolyte, and the aforementioned negative electrode sheet. The preparation method of the lithium battery includes:

a positive active material (LiNi_{0.8}Co_{0.15}Al_{0.05}O₂), a conductive additive (carbon nanotubes), and a binder (sodium carboxymethyl cellulose) are mixed uniformly in a solvent to obtain a positive electrode slurry. Then, the positive electrode slurry is evenly coated on the positive current collector aluminum foil, and after drying and rolling, a positive electrode sheet is obtained. The aforementioned negative electrode sheet, an ester electrolyte, a separator, and the positive electrode sheet are assembled to obtain the lithium battery.

### Embodiment 5

This embodiment provides a negative electrode for a lithium-ion battery with no surface lithium deposition phenomenon, its structure being consistent with Embodiment 1. The preparation method includes:
(1) The commercially available active material (silicon-carbon composite) of a negative electrode for a lithium-ion battery, a conductive additive acetylene black, carbon nanotubes, and binders CMC and SBR are mixed uniformly in a water solvent to obtain a negative electrode slurry. The slurry is then evenly coated onto the surface of the copper foil current collector, and after drying and rolling, a silicon-carbon negative electrode sheet is obtained.
(2) The obtained silicon-carbon negative electrode sheet is sputter coated with a layer of Li₃PO₄ with a thickness of 1 μm using a magnetron sputtering method, thereby obtaining a silicon-carbon negative electrode with confined insulating coating.

This embodiment also provides a lithium battery comprising the aforementioned Li₃PO₄ coated silicon-carbon negative electrode, which includes a positive electrode sheet, an electrolyte, and the aforementioned negative electrode sheet. The preparation method of the lithium battery includes:

a positive active material (LiNi_{0.8}Co_{0.15}Al_{0.05}O₂), a conductive additive (carbon nanotubes), and a binder (sodium carboxymethyl cellulose) are mixed uniformly in a solvent to obtain a positive electrode slurry. Then, the positive electrode slurry is evenly coated on the positive current collector aluminum foil, and after drying and rolling, a positive electrode sheet is obtained. The aforementioned negative electrode sheet, an ester electrolyte, a separator, and the positive electrode sheet are assembled to obtain the lithium battery.

### Embodiment 6

This embodiment provides a negative electrode for a lithium-ion battery with no surface lithium deposition phenomenon, its structure being consistent with Embodiment 1. The preparation method includes:
(1) The commercially available active material (graphite) of a negative electrode for a lithium-ion battery, a conductive additive acetylene black, carbon nanotubes, and binders CMC and SBR are mixed uniformly in a water solvent to obtain a negative electrode slurry. The slurry is then evenly coated onto the surface of the copper foil current collector, and after drying and rolling, a graphite negative electrode sheet is obtained.
(2) A layer of Al₂O₃ with a thickness of 500 nm is deposited on the surface of the graphite electrode using Plasma Enhanced Chemical Vapor Deposition (PECVD) method, thereby obtaining an Al₂O₃ insulating coated graphite negative electrode.

This embodiment also provides a lithium battery comprising the aforementioned Al₂O₃ insulating coated graphite negative electrode, which includes a positive electrode sheet, an electrolyte, and the aforementioned negative electrode sheet. The preparation method of the lithium battery includes:

a positive active material (NCM811), a conductive additives (carbon nanotubes, acetylene black), and a binder (PVDF) are mixed uniformly in a solvent to obtain a positive electrode slurry. Then, the positive electrode slurry is evenly coated on the positive current collector aluminum foil, and after drying and rolling, a positive electrode sheet is obtained. The aforementioned negative electrode sheet, an ester electrolyte, a separator, and the positive electrode sheet are assembled to obtain the lithium battery.

### Embodiment 7

This embodiment provides a negative electrode for a sodium-ion battery with no surface sodium deposition phenomenon, its structure being consistent with Embodiment 1. The preparation method includes:
(1) The commercially available active material (hard carbon) of a negative electrode for a sodium-ion battery, a conductive additive acetylene black, carbon nanotubes, and binders CMC and SBR are mixed uniformly in a water solvent to obtain a negative electrode slurry. The slurry is then evenly coated onto the surface of the copper foil current collector, and after drying and rolling, a hard carbon negative electrode sheet is obtained.
(2) Using a magnetron sputtering method, a layer of Al₂O₃ with a thickness of 1 μm is sputtered onto the surface of the obtained hard carbon negative electrode sheet. Thereby, a confined insulating coated hard carbon negative electrode is obtained.

This embodiment also provides a sodium battery comprising the aforementioned Al₂O₃ insulating coated hard carbon negative electrode, which includes a positive electrode sheet, electrolyte, and the aforementioned negative electrode sheet. The preparation method of the sodium battery includes:

a positive active material (NaCoO₂), a conductive additives (carbon nanotubes), and a binder (sodium carboxymethyl cellulose) are mixed uniformly in the solvent to obtain a positive electrode slurry. Then, the positive electrode slurry is evenly coated on the positive current collector aluminum foil, and after drying and rolling, a positive electrode sheet is obtained. The aforementioned negative electrode sheet, an ester electrolyte, a separator, and the positive electrode sheet are assembled to obtain the sodium battery.

### Comparative Example 1

This comparative example provides a lithium battery using a conventional negative electrode sheet. The preparation method is as follows:
(1) The commercially available active material (silicon-carbon composite) of a negative electrode for a lithium-ion battery, a conductive additive acetylene black, carbon nanotubes, and binders CMC and SBR are mixed uniformly in a water solvent to obtain a negative electrode slurry. The slurry is then evenly coated onto the surface of the copper foil current collector, and after drying and rolling, a silicon-carbon negative electrode sheet is obtained.
(2) a positive active material (LiNi_{0.8}Co_{0.15}Al_{0.05}O₂), a conductive additive (carbon nanotubes), and a binder (sodium carboxymethyl cellulose) are mixed uniformly in the solvent to obtain a positive electrode slurry. Then, the positive electrode slurry is evenly coated on the positive current collector aluminum foil, and after drying and rolling, a positive electrode sheet is obtained.
(3) The aforementioned negative electrode sheet, an ester electrolyte, a separator, and the positive electrode sheet are assembled to obtain the lithium battery.

### Comparative Example 2

This comparative example provides a lithium battery using a conventional negative electrode sheet. The preparation method is as follows:
(1) The commercially available active material (graphite) of a negative electrode for a lithium-ion battery, a conductive additive acetylene black, and binders CMC and SBR are mixed uniformly in a water solvent to obtain a negative electrode slurry. The slurry is then evenly coated onto the surface of the copper foil current collector, and after drying and rolling, a graphite negative electrode sheet is obtained.
(2) a positive active material (LiFePO₄), a conductive additive (conductive carbon black), and a binder (PVDF) are mixed uniformly in the solvent NMP to obtain a positive electrode slurry. Then, the positive electrode slurry is evenly coated on the positive current collector aluminum foil, and after drying and rolling, a positive electrode sheet is obtained.
(3) The aforementioned negative electrode sheet, an ester electrolyte, a separator, and the positive electrode sheet are assembled to obtain the lithium battery.

### Comparative Example 3

This comparative example provides a lithium battery utilizing a conventional negative electrode sheet. The preparation method is as follows:
(1) The commercially available active material (hard carbon) of a negative electrode for a sodium-ion battery, a conductive additive acetylene black, and binders CMC and SBR are mixed uniformly in a water solvent to obtain a negative electrode slurry. The slurry is then evenly coated onto the surface of the copper foil current collector, and after drying and rolling, a hard carbon negative electrode sheet is obtained.
(2) a positive active material (NaCoO₂), a conductive additive (conductive carbon black), and a binder (PVDF) are mixed uniformly in the solvent NMP to obtain a positive electrode slurry. Then, the positive electrode slurry is evenly coated on the positive current collector aluminum foil, and after drying and rolling, a positive electrode sheet is obtained.
(3) The aforementioned negative electrode sheet, an ester electrolyte, a separator, and the positive electrode sheet are assembled to obtain a sodium battery.

What is claimed is:

1. A negative electrode for a lithium/sodium ion battery without surface lithium/sodium deposition phenomena, comprising:
a negative electrode of a commercial lithium/sodium ion battery and an electron insulating modification layer confined conformally coated thereon; the negative electrode of the commercial lithium/sodium ion battery comprises a metal current collector, and a composite layer of the negative electrode; the electron insulating modification layer has a thickness of 10-1000 nm, and is conformally coated on a surface of powder particles of the upper layer in the composite negative electrode, wherein the electron insulating modification layer is a porous thin film, and serves as an insulating shell for the powder particles in upper layer of the composite negative electrode.

2. The negative electrode for the lithium/sodium ion battery of claim 1, wherein, the electron insulating modification layer comprises an electron insulating or low electron conductivity organic material, inorganic material, or a mixture thereof.

3. The negative electrode for the lithium/sodium ion battery of claim 2, wherein, the electron insulating modification layer is selectively conformally coated on the surface of the powder particles of upper layer in the composite negative electrode, and pores between the powder particles of the upper layer are not blocked by the electron insulating modification layer, forming a porous coating layer.

4. The negative electrode for the lithium/sodium ion battery of claim 2, wherein, the electron insulating modification layer of the organic material is soluble in a solvent, wherein the solvent is an aqueous solution or organic solvent, comprising at least one of N,N-Dimethylformamide (DMF), N,N-Dimethylacetamide (DMAC), Dimethyl sulfoxide (DMSO), n-Hexane, N-Methylpyrrolidone (NMP).

5. The negative electrode for the lithium/sodium ion battery of claim 1, wherein, the powder composite layer of the negative electrode comprises an active material, a conductive additive, and a binder, wherein the active material comprises at least one of graphite, silicon-carbon composite material, hard carbon, sub-silicon oxide; the conductive additive is at least one of carbon black, carbon nanotubes; the binder is at least one of Polyvinylidene fluoride (PVDF), Carboxymethyl cellulose (CMC), Styrene Butadiene Rubber (SBR), Polytetrafluoroethylene (PTFE), and the inherent porous structure between particles of the powder composite layer of the negative electrode allows for an electrolyte wetting therein.

6. The negative electrode for the lithium/sodium ion battery of claim 1, wherein, the negative electrode for the lithium ion battery allows for a working potential below 0 V vs. Li/Li⁺.

7. The negative electrode for the lithium/sodium ion battery of claim 1, wherein, the negative electrode for the sodium ion battery allows for a working potential below 0 V vs. Na/Na⁺.

8. A preparation method for the negative electrode for the lithium/sodium ion battery without surface lithium/sodium deposition phenomena of claim 1, comprising:
dissolving insulating components in a solvent to form a solution, wherein the insulating components comprise at least one of Ethylene-Vinyl Alcohol Copolymer (EVOH), Ethylene Propylene Diene Monomer (EPDM), Polyvinylidene Fluoride-Hexafluoropropylene Copolymer (PVDF-HFP), Polyacrylic Acid (PAA), Polyvinylidene Fluoride (PVDF), Li₂S, Li₂O, Al₂O₃, Li₃PO₄;
coating a negative powder composite of the lithium/sodium ion battery onto the metal current collector to prepare a negative electrode sheet for the lithium/sodium ion battery; and
spraying the solution onto a surface of the prepared negative electrode sheet for the lithium/sodium ion battery, and immediately drying it, allowing for a rapid evaporation of the solvent, to obtain the negative electrode sheet, wherein the surface of the composite powder particles on a top surface of the negative electrode sheet is coated with an insulating layer, while the remaining powder particles of the powder composite layer of the negative electrode on the negative electrode sheet have no electron insulating layer coated thereon, thereby obtaining a confined conformally coated modified negative electrode sheet.

9. The preparation method of claim 8, wherein, during the spraying, a coating thickness of the insulating coating layer can be controlled by adjusting a flow rate of the spraying, a solution concentration, and a number of spraying times, and/or regulating a confined coating range of the insulating coating layer within the powder composite layer of the negative electrode.

10. The preparation method of claim 8, wherein, the insulating coating layer sprayed is confinedly coated on the surface of the powder particles of the upper layer of the negative electrode sheet, wherein the insulating coating layer covers an upper surface and side surface of the powder particles of the upper layer in the composite negative electrode, while pores between the internal particles of the negative electrode sheet have substantially no insulating material attached.

11. The preparation method of claim 8, wherein, an inorganic insulating layer can be prepared using a Physical Vapor Deposition (PVD) or Chemical Vapor Deposition (CVD) method to achieve a porous coating layer, wherein the Physical Vapor Deposition method is selected from one of Magnetron Sputtering, Electron Beam Coating, and Thermal Evaporation Coating methods, and the Chemical Vapor Deposition method is selected from one of Plasma Enhanced Chemical Vapor Deposition, and Atomic Layer Deposition methods.
